(19) United States
(12) Patent Application Publication
(10) Pub. No.: US 2016/0112535 A1
(43) Pub. Date: Apr. 21, 2016

(54) METHOD FOR GENERATING GROUP OF CONTENT CACHE AND METHOD FOR PROVIDING CONTENT

(71) Applicant: ELECTRONICS AND TELECOMMUNICATIONS RESEARCH INSTITUTE, Daejeon (KR)

(72) Inventor: Kisoon SUNG, Daejeon (KR)

(73) Assignee: ELECTRONICS AND TELECOMMUNICATIONS RESEARCH INSTITUTE, Daejeon (KR)

(21) Appl. No.: 14/669,987

(22) Filed: Mar. 26, 2015

(30) Foreign Application Priority Data
Oct. 20, 2014 (KR) 10-2014-0142041

(51) Int. Cl. H04L 29/08

(52) U.S. Cl. CPC H04L 67/2852; H04L 67/16

(57) ABSTRACT

A method for forming a content cache group is provided, including: searching for a master content cache of a content cache group; and when a response is received from the master content cache, transmitting a content list regarding content stored in a mobile content cache to the master content cache, and a method for providing content shared by a content cache group to a terminal.

### CROSS-REFERENCE TO RELATED APPLICATION

This application claims priority to and the benefit of Korean Patent Application No. 10-2014-0142041 filed in the Korean Intellectual Property Office on Oct. 20, 2014, the entire contents of which are incorporated herein by reference.

### BACKGROUND OF THE INVENTION

(a) Field of the Invention

The present invention relates to a method for generating a content cache group among mobile content caches, and a method for providing content through a mobile content cache group.

(b) Description of the Related Art

Recently, as smartphones and broadband networks have become prevalent, Internet traffic has explosively increased. In particular, statistics show that 65% or more of Internet traffic is high image quality video and sound source content. Content popular among people is repeatedly transmitted via a network, and such repeated transmission is one of factors degrading network quality. Thus, network load reduction measures such as installation of a cache, or the like, have been applied at the instigation of communication providers.

In the mobile communication field that is vulnerable to an amount of transmitted and received data, research into moving a content server or a cache to a stage in front of a base station has been conducted. When a content server or a cache is introduced to a small cell base station, a femto cell base station, a mobile small cell base station, or a terminal, content servers or caches may exist more densely, relative to an existing network. In this case, sharing a content list between content servers or caches and transmission requested content with each other may play a significant role in reducing a load of a core network.

In order to inform about a server where particular content is positioned, 1) a method of accessing a content server and making a detour to a cache or 2) a method in which a server indicating a position of content independently exists (e.g., torrent, tracker, etc.) are used. In the mobile communication field, however, in a case in which a base station or a terminal of a mobile small cell serves as a content server or a cache, a position of a server needs to be continuously tracked, and thus the foregoing methods may be inconvenient.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus enabling a mobile small cell base station or a terminal, when providing a content server or cache function, to dynamically generate a connection to form a content cache group and share content lists to provide content to users.

An exemplary embodiment of the present invention provides a method for forming a content cache group of a mobile content cache. The group forming method may include: searching for a master content cache of the content cache group; and when a response is received from the master content cache, transmitting a content list regarding content stored in the mobile content cache to the master content cache.

The group forming method may further include, when a response is not received from the master content cache, operating as a first master content cache of a content cache group other than the content cache group.

The group forming method may further include: after the transmitting, transmitting a separation message to the master content cache; and withdrawing from the content cache group.

The group forming method may further include: after the transmitting, periodically receiving a confirmation signal from the master content cache; and responding to the confirmation signal.

The group forming method may further include: after the transmitting, receiving a separation message from the master content cache; and negotiating with other mobile content caches included in the content cache group to determine a next master content cache.

The group forming method may further include: when at least two confirmation signals are received, informing the master content cache that at least one different master content cache is present nearby; and receiving a confirmation signal transmitted from a next master content cache determined among the master content cache and the at least one different master content cache.

Another embodiment of the present invention provides a method for forming a mobile content cache group. The group forming method may include: receiving a search message from a first mobile content cache which joins the content cache group; transmitting a response message with respect to the search message, to the first mobile content cache; and receiving a content list regarding content stored in the first mobile content cache from the first mobile content cache.

The group forming method may further include: periodically transmitting a confirmation signal to at least one slave content cache included in the content cache group; receiving a response signal with respect to the confirmation signal from the at least one slave content cache; and when there is a first slave content cache which has not transmitted a response signal, among the at least one slave content cache, deleting information regarding the first slave content cache.

The deleting may include deleting a content list of content stored in the first slave content cache.

The group forming method may further include: receiving a separation message from a second slave content cache among slave content caches included in the content cache group; and deleting information regarding the second slave content cache.

The deleting may include deleting a content list of content stored in the second slave content cache.

The group forming method may further include: transmitting a separation message to a slave content cache included in the content cache group; and withdrawing from the content cache group.

The group forming method may further include, when a message indicating that at least one different master content cache is present nearby from a slave content cache which has received the confirmation signal is received, determining a next master content cache among the at least one master content cache and the mobile content cache.

The determining may include: comparing content lists stored in the at least one master content cache; and determining a content cache having a larger number of content items on the content list, as a next master content cache.

The determining may include: comparing the number of slave content caches connected to the at least one master content cache and the number of slave content caches connected to the mobile content cache; and determining a content cache having a larger number of slave content caches, as a next master content cache.

Yet another embodiment of the present invention provides a method for providing content from a mobile content cache to a terminal. The content providing method may include: receiving a content providing request from a terminal; searching whether the content is present in a first repository of a mobile content cache; when the content is present in the first repository, providing the content to the terminal; and when the content is not present in the first repository, delivering the content providing request to a master content cache of a content cache group to which the mobile content cache belongs.

The content providing method may further include: when the content is present on the content list of the master content cache, receiving information regarding a first mobile content cache storing the content, among other mobile content caches included in the content cache group; and requesting the content from the first mobile content cache, receiving the content from the first mobile content cache, and transmitting the received content to the terminal.

The content providing method may further include: when the content is not present on the content list of the master content cache, requesting the content from a content server; and receiving the content from the content server and transmitting the received content to the terminal.

### BRIEF DESCRIPTION OF THE DRAWINGS

FIG. 1 is a view illustrating a content transmission network including a mobile content cache according to an exemplary embodiment of the present invention.

FIG. 2 is a flowchart illustrating a method for generating a mobile content cache group according to an exemplary embodiment of the present invention.

FIG. 3 is a flowchart illustrating a method for maintaining a mobile content cache group according to an exemplary embodiment of the present invention.

FIG. 4 is a flowchart illustrating a method in which a slave mobile content cache leaves a mobile content cache group according to an exemplary embodiment of the present invention.

FIG. 5 is a flowchart illustrating a method in which a master mobile content cache leaves a mobile content cache group according to an exemplary embodiment of the present invention.

FIG. 6 is a view illustrating a network including a plurality of masters according to an exemplary embodiment of the present invention.

FIG. 7 is a flowchart illustrating a method for transmitting content according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a mobile station (MS) may refer to a terminal, a mobile terminal (MT), an advanced mobile station (AMS), a high reliability mobile station (HR-MS), a subscriber station (SS), a portable subscriber station (PSS), an access terminal (AT), user equipment (UE), or the like, and may include an entirety or a portion of functions of an MT, an MS, an AMS, an HR-MS, an SS, a PSS, an AT, a UE, or the like.

Also, a base station (BS) may refer to an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as a base station, a relay node (RN) serving as a base station, an advanced relay station (ARS) serving as a base station, a high reliability relay station (HR-RS) serving as a base station, small base stations (BSs) (e.g., a femto base station (BS), a home node B (HNB), a home eNodeB (HeNB), a pico BS, a metro BS, a micro BS, etc.), and the like, and may include the entirety or a portion of functions of an ABS, a node B, an eNodeB, an AP, an RAS, a BTS, an MMR-BS, an RS, an RN, an ARS, an HR-RS, a small BS, or the like.

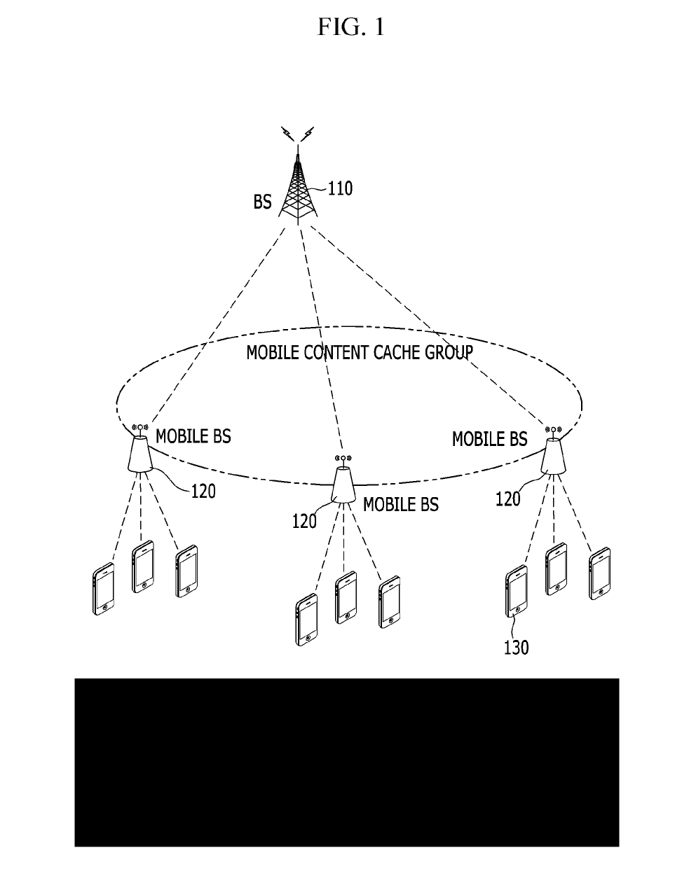

FIG. 1 is a view illustrating a content transmission network including a mobile content cache according to an exemplary embodiment of the present invention.

Referring to FIG. 1, a plurality of mobile base stations (BSs) 120 are connected to a BS 110, and mobile content caches of the mobile BSs 120 may provide content to a plurality of terminals 130 connected thereto. The mobile content caches are grouped together to share a content list. Thus, even though content is not stored in a mobile content cache connected to the terminal 130, the terminal 130 may download desired content from a neighbor mobile content cache.

The mobile content cache group includes a master mobile content cache (hereinafter referred to as a “master”) and a slave mobile content cache (hereinafter referred to as a “slave”). The master may collect and manage a content list. At least one master may exist in the mobile content cache group. The slave may transmit a list of content thereof to the master to thereby share content lists with other mobile content caches.

In general, a user downloads content from a content server or a cache of a network. However, if it is possible for the user to download desired content from a small cell BS, a femto cell BS, or a neighboring terminal (hereinafter referred to as a “mobile content cache”), a significant gain may be obtained in terms of network resource efficiency.

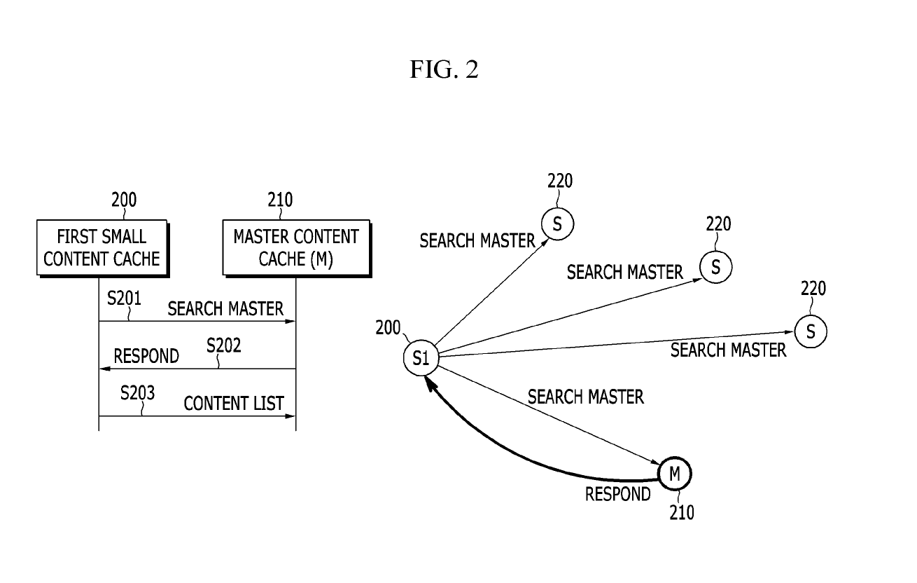

FIG. 2 is a flowchart illustrating a method for generating a mobile content cache group according to an exemplary embodiment of the present invention.

Referring to FIG. 2, when a mobile content cache (a first mobile content cache) 200, among mobile content caches, wants to join a mobile content cache group, the first mobile content cache 200 broadcasts a search message for searching for a master 210 (S201).

The master 210 of the mobile content cache group responds to the first mobile content cache 200 (S202). Thereafter, the first mobile content cache 200 transmits a list of content stored in the first mobile content cache 200 to the master 210 (S203) to share the content list with other mobile content caches 220.

In this case, if no master responds to the search message, the first mobile content cache 200 may become a master of a mobile content cache group.

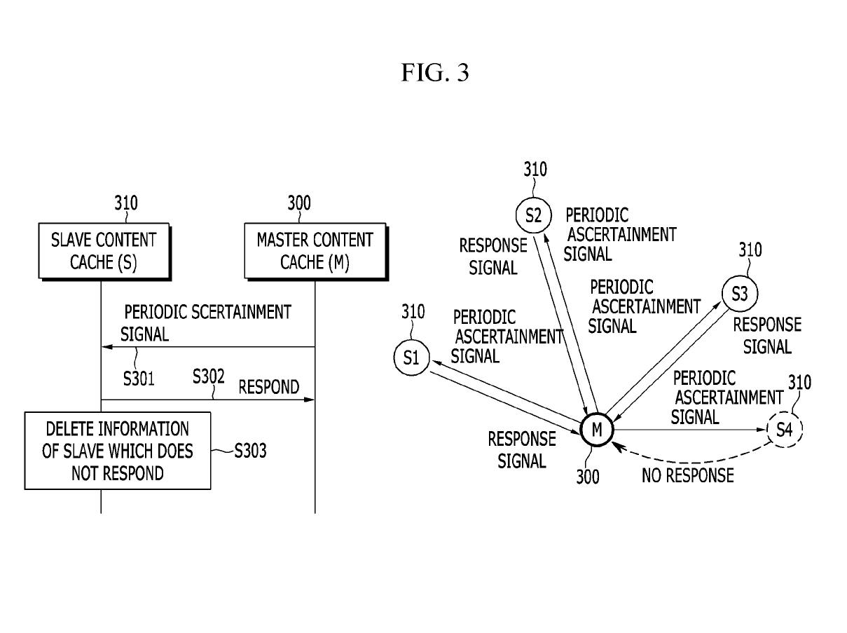

FIG. 3 is a flowchart illustrating a method for maintaining a mobile content cache group according to an exemplary embodiment of the present invention.

A master 300 periodically transmits a confirmation signal (or a confirmation beacon) inquiring whether a slave 310 remains in the group, to the slave 310 (S301). When the slave 310 remains in the mobile content cache group, the slave 310 transmits a response to the master 300 (S302).

Thereafter, when a preset period of time has lapsed, the master 300 deletes content information and information of the slave 310 which does not respond to the periodic confirmation signal (S303). That is, the master 300 deletes the content list of the slave 310 which does not respond to the periodic confirmation signal.

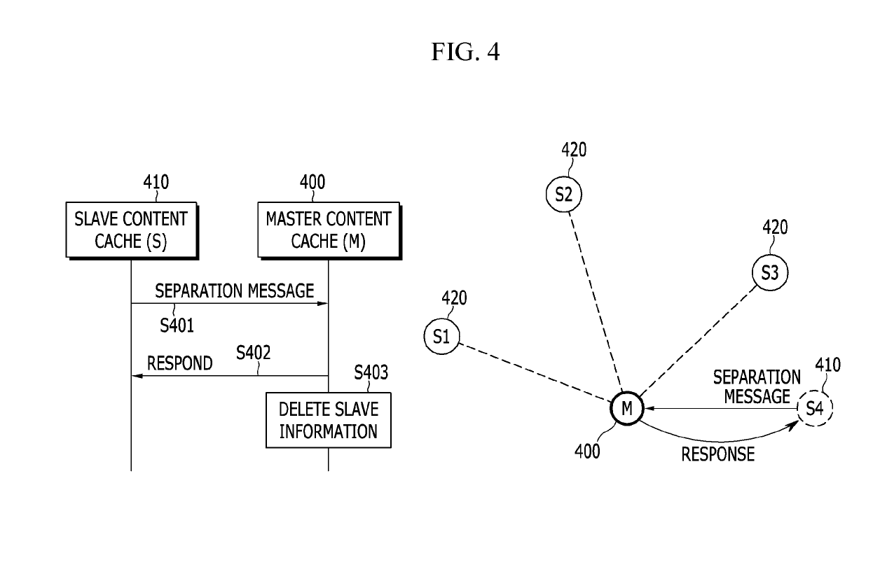

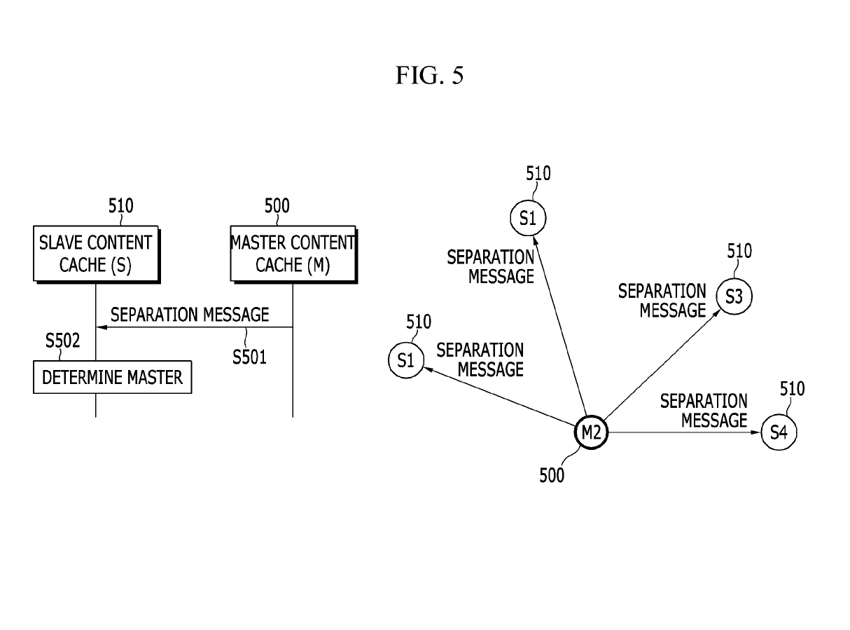

FIG. 4 is a flowchart illustrating a method in which a slave mobile content cache leaves a mobile content cache group according to an exemplary embodiment of the present invention, and FIG. 5 is a flowchart illustrating a method in which a master mobile content cache leaves a mobile content cache group according to an exemplary embodiment of the present invention.

In FIG. 4, when a slave 410 wants to withdraw from the mobile content cache group, the slave 410 transmits a separation message to a master 400 (S401) to request deletion of information of the slave 410. Upon receiving the separation message, the master 400 transmits a response to the corresponding slave 410 (S402) and deletes information of the corresponding slave (S403).

In FIG. 5, when a master 500 wants to withdraw from a mobile content cache group, the master 500 transmits a separation message to all the slaves 510 included in the mobile content cache group (S501). After the master 500 is withdrawn, at least one of slaves 510 may be switched to a next master according to determination of at least one slave 510 included in the mobile content cache group (S502).

Meanwhile, when a mobile content cache has mobility, masters of several groups may meet in some cases. In this case, masters of several groups may be integrated to a single master through negotiation among the masters.

Duplication of masters may be discovered when a plurality of masters respond to a search message broadcasted by a slaver to search for a master, or when masters transmit periodic signals to manage a mobile content cache group.

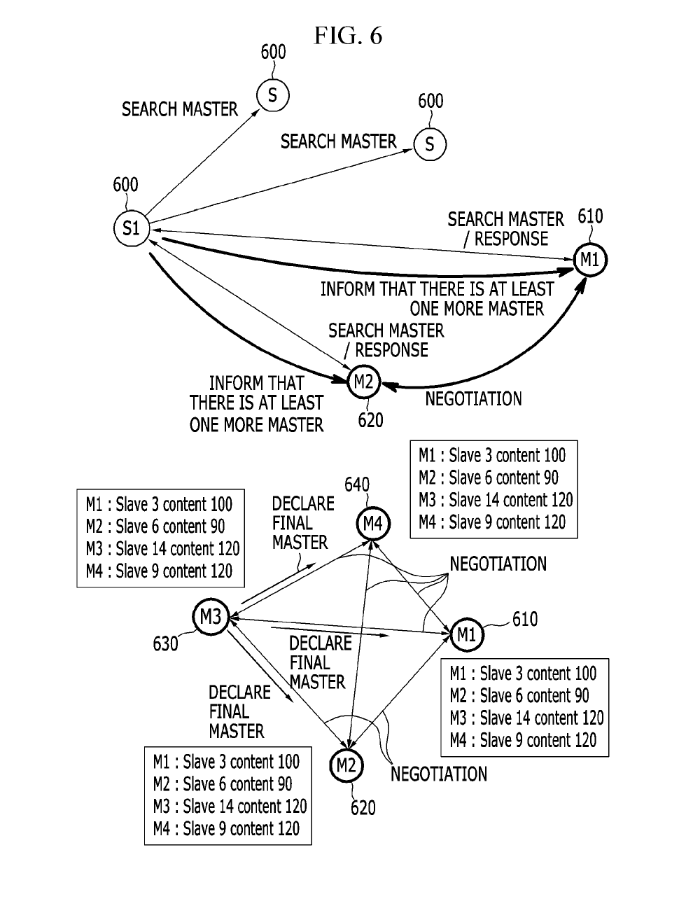

FIG. 6 is a view illustrating a network including a plurality of masters according to an exemplary embodiment of the present invention.

First, referring to FIG. 6, when a slave 600 recognizes that at least one master 620 exists within a predetermined range, the slave 600 informs a master 610 of a mobile content cache group to which the slave 600 belongs. When the master 610 recognizes that another master 620 is present nearby according to the report from the slave 600, the master 610 searches for the master 620. The number of slaves 600 retained by the masters 610 and 620 and the number of content items stored in the mobile content cache group are exchanged. Here, the exchanging may be performed in a broadcast manner.

Thereafter, referring to a lower portion of FIG. 6, masters 610 to 640 individually determine whether to serve as a master on the basis of information received from other masters. According to an exemplary embodiment of the present invention, a mobile content cache retaining the largest number of slaves or content items may continue to serve as a master. In the lower portion of FIG. 6, since there are 14 slaves connected to the third master 630 and there are 129 content items stored in the third master 630, the third master 630 may serve as a final master.

Here, the mobile content cache which continues to serve as a master may be a mobile content cache having the largest number of slaves connected thereto or a mobile content cache having the largest number of content items included in the shared content list. The mobile content cache which continues to serve as a master declares that the mobile content cache itself is a final master. Thereafter, the final master collects information of slaves connected to each master and content lists.

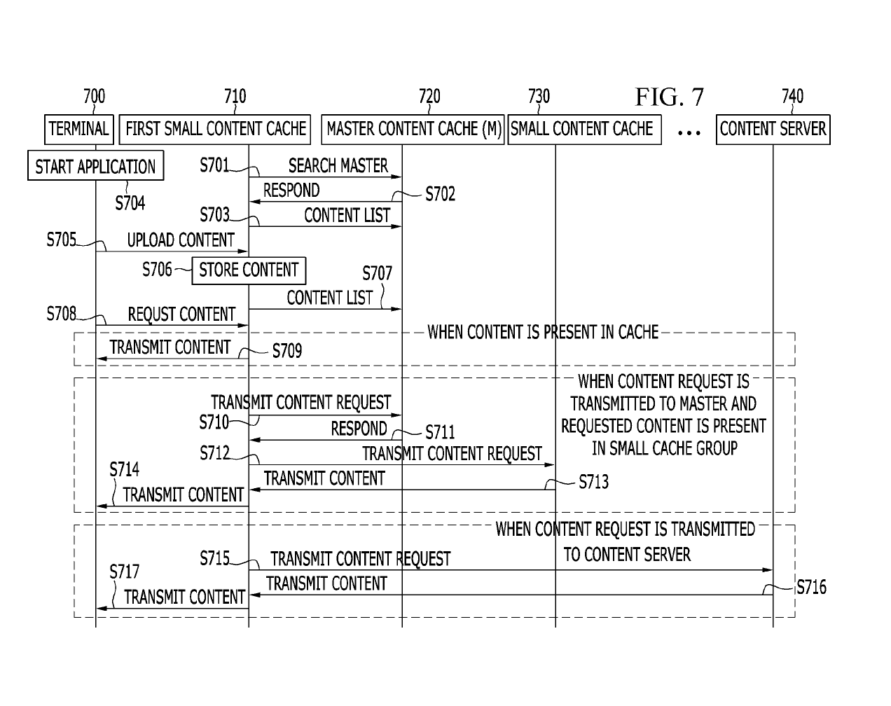

FIG. 7 is a flowchart illustrating a method for transmitting content according to an exemplary embodiment of the present invention.

Referring to FIG. 7, in order to join a mobile content cache group, a first mobile content cache 710 broadcasts a search message for searching for a master 720 (S701). Thereafter, when a response is received from the master 720 (S702), the first mobile content cache 710 transmits a content list to the master 720 (S703).

Meanwhile, a user of a terminal 700, which has executed an application, uploads content to the first mobile content cache 710 (S704, S705), and the first mobile content cache 710 stores the content uploaded from the terminal 700 (S706). The first mobile content cache 710 transmits a content list in which information regarding the content uploaded from the terminal 700 has been updated to the master 720 (S707). Thereafter, other terminals connected to the first mobile content cache 710 may share the content uploaded from the terminal 700.

Thereafter, the user of the terminal 700 requests content from the first mobile content cache 710. The content request may be made as the user executes a content downloading application of the terminal 700 and inputs a keyword of desired content.

The first mobile content cache 710 searches whether the content requested by the user is present in a repository (cache) thereof. When the content is present in the repository of the first mobile content cache 710, the first mobile content cache 710 transmits the content to the terminal 700.

However, when the content is not present in the repository of the first mobile content cache 710, the first mobile content cache 710 transmits a content request to the master 720. The master 720 searches whether the content is included in a content list thereof. When the content is included in the content list stored in the master 720, the master informs the first mobile content cache 710 of a mobile content cache 730 in which the content is present. Thereafter, the first mobile content cache 710 request to download the content from the mobile content cache 730.

However, when the content is not present in the mobile content cache group in which the first mobile content cache 710 is included, the first mobile content cache 710 finally requests the content from a content server 740. Thereafter, the first mobile content cache 710 may transmit the content downloaded from the content server 740 to the terminal 700.

According to the exemplary embodiment of the present disclosure described above, mobile content caches may form a group by simply exchanging messages, and content such as video having a large capacity, or the like, may be promptly shared by the mobile content cache group, without having to be transmitted to a core network, whereby a load of the core network can be distributed. In particular, in an exemplary embodiment of the present disclosure, video content, or the like, imaged in an environment in which a large crowd carries around mobile content caches such as in a baseball park can be promptly shared by a mobile content cache group leading to less network load.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for forming a content cache group of a mobile content cache, the method comprising:
searching for a master content cache of the content cache group; and
when a response is received from the master content cache, transmitting a content list regarding content stored in the mobile content cache to the master content cache.

2. The method of claim 1, further comprising, when a response is not received from the master content cache, operating as a first master content cache of a content cache group other than the content cache group.

3. The method of claim 1, further comprising after the transmitting, transmitting a separation message to the master content cache and withdrawing from the content cache group.

4. The method of claim 1, further comprising, after the transmitting, periodically receiving a confirmation signal from the master content cache and responding to the confirmation signal.

5. The method of claim 1, further comprising:
after the transmitting,
receiving a separation message from the master content cache; and
negotiating with other mobile content caches included in the content cache group to determine a next master content cache.

6. The method of claim 4, further comprising:
when at least two confirmation signals are received, informing the master content cache that at least one different master content cache is present nearby; and
receiving a confirmation signal transmitted from a next master content cache determined among the master content cache and the at least one different master content cache.

7. A method for forming a mobile content cache group, the method comprising:
receiving a search message from a first mobile content cache which joins the content cache group;
transmitting a response message with respect to the search message, to the first mobile content cache; and
receiving a content list regarding content stored in the first mobile content cache from the first mobile content cache.

8. The method of claim 7 further comprising:
periodically transmitting a confirmation signal to at least one slave content cache included in the content cache group;
receiving a response signal with respect to the confirmation signal from the at least one slave content cache; and
when there is a first slave content cache which has not transmitted a response signal, among the at least one slave content cache, deleting information regarding the first slave content cache.

9. The method of claim 8, wherein the deleting includes deleting a content list of content stored in the first slave content cache.

10. The method of claim 7, further comprising:
receiving a separation message from a second slave content cache among the at least one slave content cache included in the content cache group; and
deleting information regarding the second slave content cache.

11. The method of claim 10, wherein the deleting includes deleting a content list of content stored in the second slave content cache.

12. The method of claim 7, further comprising:
transmitting a separation message to a slave content cache included in the content cache group; and
withdrawing from the content cache group.

13. The method of claim 8, wherein, when a message indicating that at least one different master content cache is present nearby from a slave content cache which has received the confirmation signal is received, determining a next master content cache among the at least one master content cache and the mobile content cache.

14. The method of claim 13, wherein the determining includes:
comparing content lists stored in the at least one master content cache; and
determining a content cache having a larger number of content items on the content list, as a next master content cache.

15. The method of claim 14, wherein the determining includes:
comparing the number of slave content caches connected to the at least one master content cache and the number of slave content caches connected to the mobile content cache; and
determining a content cache having a larger number of slave content caches, as a next master content cache.

16. A method for providing content from a mobile content cache to a terminal, the method comprising:
receiving a content providing request from the terminal;
searching whether the content is present in a first repository of the mobile content cache;
when the content is present in the first repository, providing the content to the terminal; and
when the content is not present in the first repository, delivering the content providing request to a master content cache of a content cache group to which the mobile content cache belongs.

17. The method of claim 16, further comprising:
when the content is present on the content list of the master content cache, receiving information regarding a first mobile content cache storing the content, among other mobile content caches included in the content cache group; and
requesting the content from the first mobile content cache, receiving the content from the first mobile content cache, and transmitting the received content to the terminal.

18. The method of claim 17, further comprising:
when the content is not present on the content list of the master content cache, requesting the content from a content server; and
receiving the content from the content server and transmitting the received content to the terminal.
